(19) United States
(12) Patent Application Publication
(10) Pub. No.: US 2024/0111597 A1
(43) Pub. Date: Apr. 4, 2024

(54) DYNAMIC ADJUSTMENT OF REVOCABLE RESOURCES IN A MULTI-CLOUD ENVIRONMENT FOR PERFORMING A WORKLOAD

(71) Applicant: International Business Machines Corporation, Armonk, NY (US)

(72) Inventors: Guang Han Sui, Beijing (CN); Wei Ge, Beijing (CN); Lan Zhe Liu, BEIJING (CN); Guo Liang Wang, BEIJING (CN)

(21) Appl. No.: 17/956,993

(22) Filed: Sep. 30, 2022

(51) Int. Cl. G06F 9/50

(52) U.S. Cl. CPC G06F 9/505; G06F 9/5022; G06F 9/5038; G06F 9/5077

(57) ABSTRACT

A present invention embodiment requests resources for a set of tasks from different resource providers. The set of tasks includes first tasks and second tasks of longer duration than the first tasks. The resources are revocable by the different resource providers based on processing demand. Performance of the first tasks is initiated on the resources, and stable resources are identified based on revocation of the resources during performance of the first tasks. Performance of the second tasks are initiated on the identified stable resources. Requests for the resources to the different resource providers are adjusted based on resource provider information collected in response to completion of the set of tasks.

### BACKGROUND

### 1. Technical Field

Present invention embodiments relate to cloud or distributed computing, and more specifically, to dynamically adjusting revocable resources in a multi-cloud environment for performing a workload at reduced cost.

### 2. Discussion of the Related Art

Spot instances are resources of a cloud computing system that are provided when available (e.g., from excess or unused capacity, etc.) and revoked or reclaimed in response to requests for the resources from other users. The cost for using spot instances is significantly reduced relative to use of normal resources. Applications may be executed on spot instances to reduce cost, but the applications can be interrupted. In particular, different kinds of jobs may be executed with spot instances to reduce costs. A job may include a collection of tasks that may contain up to thousands or millions of tasks. Since spot instances are not stable and may be revoked or reclaimed, the jobs may not be able to be completed. For example, jobs with long tasks executing on spot instances are interrupted frequently. Accordingly, since the tasks may not be completed, the corresponding jobs also cannot be completed, thereby wasting costs with respect to using the resources.

### SUMMARY

According to one embodiment of the present invention, a system for performing a workload with dynamic resource adjustment comprises one or more memories and at least one processor coupled to the one or more memories. The system requests resources for a set of tasks from different resource providers. The set of tasks includes first tasks and second tasks of longer duration than the first tasks. The resources are revocable by the different resource providers based on processing demand. Performance of the first tasks is initiated on the resources, and stable resources are identified based on revocation of the resources during performance of the first tasks. Performance of the second tasks are initiated on the identified stable resources. Requests for the resources to the different resource providers are adjusted based on resource provider information collected in response to completion of the set of tasks. Embodiments of the present invention further include a method and computer program product for performing a workload with dynamic resource adjustment in substantially the same manner described above.

### BRIEF DESCRIPTION OF THE DRAWINGS

Generally, like reference numerals in the various figures are utilized to designate like components.

FIG. 1 is a diagrammatic illustration of an example computing environment according to an embodiment of the present invention.

FIG. 2 is a block diagram of resource adjustment code according to an embodiment of the present invention.

FIG. 3 is a procedural flowchart of a method for performing jobs and dynamically adjusting resources according to an embodiment of the present invention.

FIG. 4 is a procedural flowchart of a method for performing jobs of a job group and dynamically adjusting resources according to an embodiment of the present invention.

FIG. 5 is a flow diagram of an example scenario for performing jobs of job groups and dynamically adjusting resources according to an embodiment of the present invention.

### DETAILED DESCRIPTION

A present invention embodiment ensures a workload can be completed with spot instances in a multi-cloud environment. The workload may include jobs, where a job may include a collection of tasks that may contain up to thousands or millions of tasks. Information pertaining to jobs is collected, and the jobs are divided into different job groups. Requests for spot instances from each job group are divided into sub-requests, and sent to different cloud providers. In the case of initial requests (with no prior analysis), the requests may be divided randomly. However, when an analysis has been performed for prior jobs, the requests may be divided based on the analysis. Shorter tasks of each job group are provided to execute initially while monitoring a status of spot instances. Longer tasks are provided to execute on stable spot instances, and unstable spot instances are released. Once the jobs in a job group are completed, the effective task execution time, cost, and other information of the cloud providers are collected. The sub-requests for different cloud providers are adjusted based on the collected information. The sub-requests for daily jobs are dynamically adjusted as described above to complete jobs with a reduced or minimum cost.

A present invention embodiment reduces costs of provisioning resources for completing jobs. Since stable spot instances are detected by shorter tasks, longer tasks in the jobs are executed on the detected stable instances, thereby being completed with less cost. Further, requests to different cloud providers are adjusted dynamically based on cloud history information to optimize provisioning of resources and ensure completion of jobs at reduced cost.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

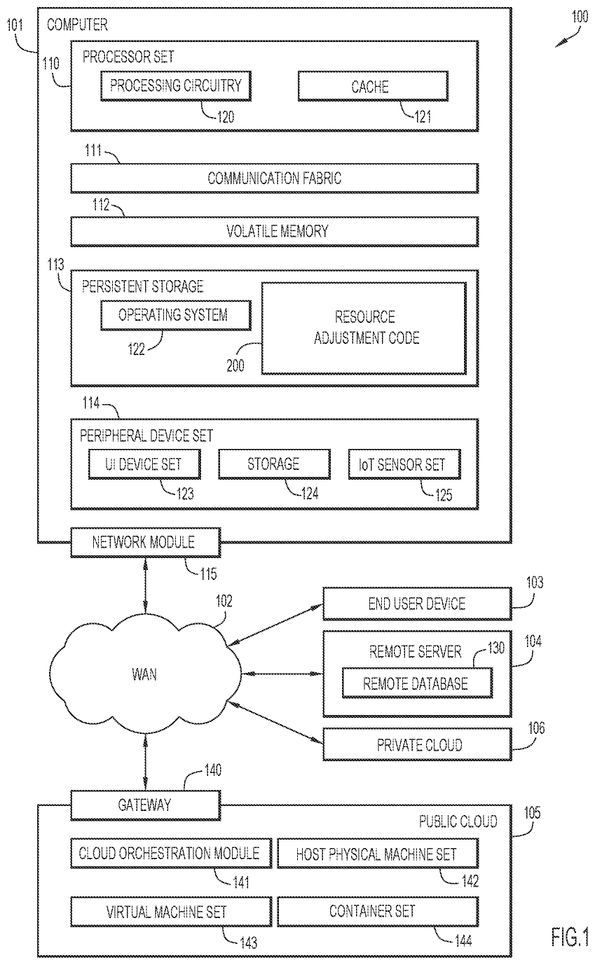

Referring to FIG. 1, computing environment 100 contains an example of an environment for the execution of at least some of the computer code involved in performing the inventive methods, such as resource adjustment code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

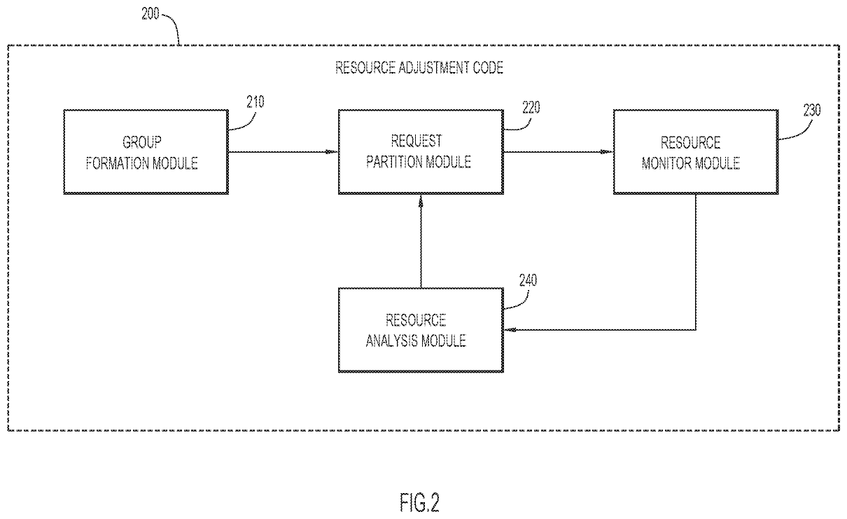

A block diagram of resource adjustment code 200 according to an embodiment of the present invention is illustrated in FIG. 2. Specifically, resource adjustment code 200 includes a group formation module 210, a request partition module 220, a resource monitor module 230, and a resource analysis module 240. Group formation module 210 collects various information pertaining to jobs of a workload. A job may include a collection of tasks that may contain up to thousands or millions of tasks. The collected information may include tasks of the jobs, processing and/or other resources needed for the tasks and/or jobs (e.g., central processing unit (CPU), graphical processing unit (GPU), memory, network, etc.), task and/or job duration, etc. The group formation module further divides or partitions the jobs into any quantity of job groups based on resource requests for the jobs. The resource requests may request processing and/or other resources needed for the job groups and/or job group tasks (e.g., central processing unit (CPU), graphical processing unit (GPU), memory, network, etc.), and may be based on the collected information. For example, jobs requiring similar resources may be grouped together (e.g., CPU/GPU, memory, and/or network resource quantities within a certain range of each other, etc.).

Request partition module 220 divides or partitions resource requests for each job group into sub-requests. This may be performed randomly, or based on a previous analysis (when an analysis has been performed based on prior performance of the job group).

Resource monitor module 230 sends the sub-requests for each job group to different resource providers (e.g., cloud or other computing resource providers (e.g., public cloud 105, etc.), etc.) to acquire the requested resources. The requested resources include revocable resources (e.g., spot instances, etc.). These types of resources are provided when available (e.g., from excess or unused capacity of a resource provider, etc.) and have lower cost, but may be unilaterally revoked or reclaimed by the resource provider based on capacity needs or demands due to requests for resources from other users. The requested (or acquired) resources (including the revocable resources) may include any quantity of instances or units of any types of resources (e.g., virtual machines, memory, networking, etc.). For example, a resource instance or unit may include a server or other virtual machine configured (e.g., with processors, memory, networking capability, etc.) to execute certain types of applications.

Resource monitor module 230 further initiates tasks to be performed or executed on the acquired resources, and monitors the status of the revocable resources during task performance. Shorter tasks of a job group are initially performed on the revocable resources. Revocable resources identified as unstable based on performance of the shorter tasks of the job group are released, while longer tasks of the job group are initiated to be performed or executed on revocable resources identified as stable. This enables the shorter tasks to serve as probes for identifying the stable revocable resources for performing the longer tasks.

Resource analysis module 240 collects information of the resource providers when the jobs of a job group are completed, and dynamically adjusts the sub-requests of the job group for the different resource providers (e.g., cloud or other computing resources (e.g., public cloud 105, etc.), etc.) based on the resource provider information. The resource provider information may include various information pertaining to performance of the tasks of the job group by a corresponding resource provider (e.g., resource provider identifier, processing time, cost, time of day, location, etc.).

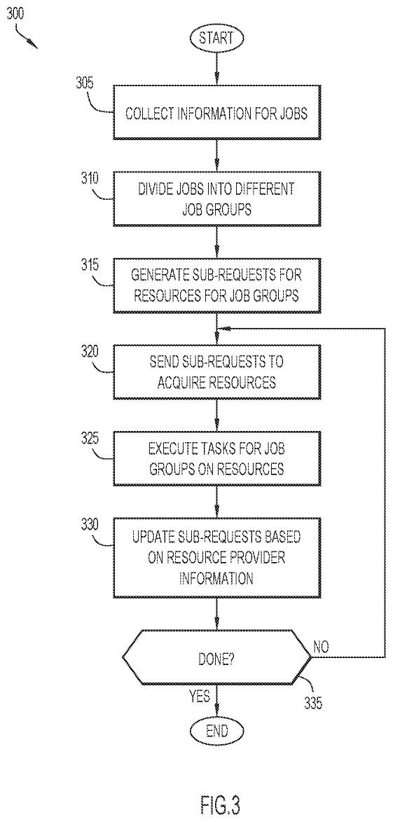

A method 300 for performing jobs and dynamically adjusting resources according to an embodiment of the present invention is illustrated in FIG. 3. Initially, group formation module 210 collects various information for jobs at operation 305. A job may include a collection of tasks that may contain up to thousands or millions of tasks. The information may include tasks of the jobs, processing and/or other resources needed for the tasks and/or jobs (e.g., central processing unit (CPU), graphical processing unit (GPU), memory, network, etc.), task and/or job duration, etc. The jobs are divided or partitioned into different job groups by the group formation module at operation 310. This may be accomplished by dividing or partitioning the jobs into the different job groups based on resource requests for the jobs. The resource requests may request processing and/or other resources needed for the job groups and/or job group tasks (e.g., central processing unit (CPU), graphical processing unit (GPU), memory, network, etc.), and may be based on the collected information. For example, jobs requiring similar resources may be grouped together (e.g., CPU/GPU, memory, and/or network resource quantities within a certain range of each other, etc.).

Request partition module 230 divides resource requests for each job group into sub-requests at operation 315. This may be performed randomly, or based on a previous analysis (when an analysis has been performed based on prior performance of the job group).

Resource monitor module 230 sends the sub-requests for each job group to different resource providers (e.g., cloud or other computing resource providers (e.g., public cloud 105, etc.), etc.) to acquire the requested resources at operation 320. The requested resources include revocable resources (e.g., spot instances, etc.). These types of resources are provided when available (e.g., from excess or unused capacity of a resource provider, etc.) and have lower cost, but may be unilaterally revoked or reclaimed by the resource provider based on capacity needs or demands due to requests for resources from other users. The requested (or acquired) resources (including the revocable resources) may include any quantity of instances or units of any types of resources (e.g., virtual machines, memory, networking, etc.). For example, a resource instance or unit may include a server or other virtual machine configured (e.g., with processors, memory, networking capability, etc.) to execute certain types of applications.

Resource monitor module 230 further initiates tasks of jobs of the job groups to be performed or executed on the acquired resources, and monitors the status of the revocable resources during performance of the tasks at operation 325. Shorter tasks of the job groups are initially performed or executed on the revocable resources for the corresponding job group. Revocable resources identified as unstable based on performance of the shorter tasks of a job group are released, while longer tasks of the job group are initiated to be performed or executed on stable revocable resources. A revocable resource may be considered unstable when a task performed by the revocable resource is interrupted (e.g., the resource is revoked or reclaimed by the resource provider, etc.) prior to completion. When an interruption occurs during task performance (e.g., the revocable resource is revoked or reclaimed by the resource provider), the task may be restarted when the revocable resource later becomes available. The shorter tasks are initially executed since the cost is low when a shorter task is interrupted.

The shorter tasks are used to determine a status of a revocable resource as stable or unstable, thereby enabling the longer tasks to use stable revocable resources to prevent significant waste of cost from interruption of the longer tasks. In other words, the shorter tasks serve as probes for identifying stable revocable resources for performing the longer tasks since interruption of a shorter task incurs a low cost. For example, a revocable resource may be allocated and revoked or reclaimed by a resource provider after ninety-five minutes. There may be ten tasks to be performed each with a duration of ten minutes (e.g., totaling one-hundred minutes). When the revocable resource is revoked or reclaimed after ninety-five minutes, the first nine tasks are completed (e.g., consuming ninety minutes) and only the last task is impacted. Thus, five minutes of the ninety-five minutes is lost or wasted (e.g., the difference between ninety-five minutes of resource use and ninety minutes of completed tasks). In contrast, when a task with a duration of one-hundred minutes is performed by the revocable resource, the task will be interrupted prior to completion. In this case, all ninety-five minutes is lost or wasted (e.g., the difference between ninety-five minutes of resource use and zero minutes of completed tasks). Accordingly, the longer tasks are protected by the shorter tasks.

Revocable resources are revoked or reclaimed by a resource provider when the resource provider has insufficient capacity to handle processing requests. However, the resource provider only revokes or reclaims revocable resources when those resources assist with providing the needed capacity. For example, a resource provider may need an entire host. In this case, revocable resources are not revoked or reclaimed since those resources cannot help attain the needed capacity (e.g., a host performs various functions and the entire host cannot be allocated for processing requests, etc.). Since revocable resources have reduced costs with respect to normal resources, a present invention embodiment attempts to maximize use of revocable resources that are not revoked or reclaimed in order to reduce or minimize costs for performing a workload.

Resource analysis module 240 collects information of the resource providers when the jobs of a job group are completed at operation 330. The resource provider information may include various information pertaining to performance of the tasks of the job group by a corresponding resource provider (e.g., resource provider identifier, processing time, cost, time of day, location, etc.). The resource analysis module adjusts the sub-requests of the job group for the different resource providers based on the resource provider information. The above process is repeated from operation 320 for future performance of jobs (e.g., periodic or scheduled jobs) until termination of the process (e.g., no further performance of jobs, etc.) as determined at operation 335. For example, the process may be applied to daily jobs to adjust the sub-requests for completing jobs using revocable resources at reduced cost. Since the sub-requests to each resource provider are adjusted dynamically, the resource provider completing the same jobs at reduced cost receives a greater quantity of the sub-requests (or requests for a greater quantity of resources), thereby reducing costs of performing the jobs.

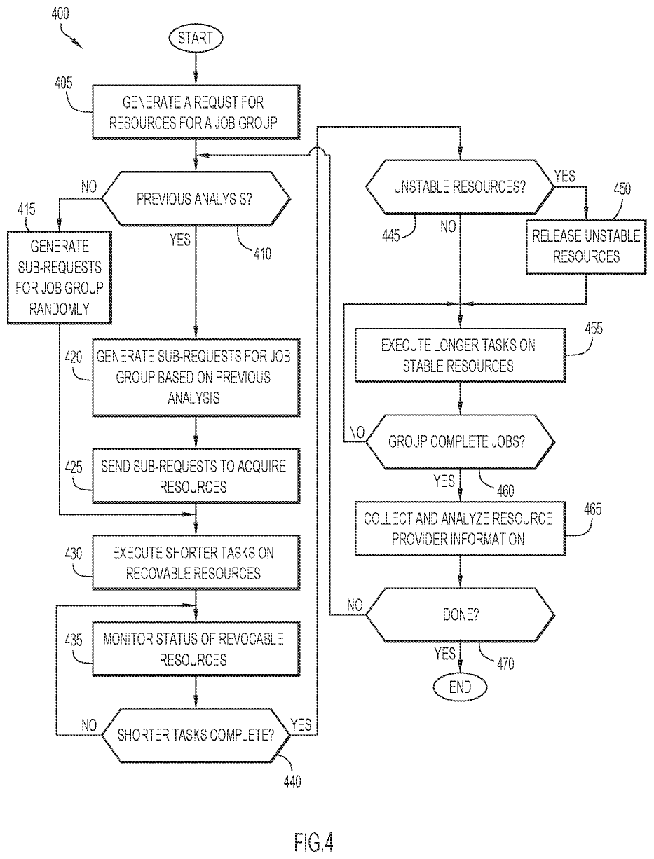

A method 400 for performing jobs of a job group and dynamically adjusting resources (e.g., corresponding to operations 315, 320, 325, and 330 of FIG. 3) according to an embodiment of the present invention is illustrated in FIG. 4. Initially, group formation module 210 collects various information for jobs of a workload, and divides or partitions the jobs into different job groups in substantially the same manner described above.

Request partition module 220 generates a resource request for a job group at operation 405. The resource request may request processing and/or other resources needed for the job group and/or job group tasks (e.g., central processing unit (CPU), graphical processing unit (GPU), memory, network, etc.), and may be based on the collected information. The request partition module further divides the resource request for the job group into sub-requests. In particular, request partition module 220 determines the presence of a previous analysis at operation 410 (e.g., an analysis performed based on prior performance of the job group). When a previous analysis does not exist, the sub-requests may be generated in a random fashion (e.g., randomly select portions of the jobs in the job group and generate corresponding sub-requests, etc.). The random selection may be accomplished by any conventional or other randomization techniques (e.g., a random number generator with random numbers corresponding to a number of sub-requests for portions of the jobs of the job group, etc.). When a previous analysis exists as determined at operation 410, the sub-requests are generated based on the previous analysis (e.g., an analysis based on prior performance of the job group) at operation 420.

Resource monitor module 230 sends the sub-requests for the job group to different resource providers (e.g., cloud or other computing resource providers (e.g., public cloud 105, etc.), etc.) to acquire the requested resources at operation 425. The requested resources include revocable resources (e.g., spot instances, etc.). These types of resources are provided when available (e.g., from excess or unused capacity of a resource provider, etc.) and have lower cost, but may be unilaterally revoked or reclaimed by the resource provider based on capacity needs or demands due to requests for resources from other users. The requested (or acquired) resources (including the revocable resources) may include any quantity of instances or units of any types of resources (e.g., virtual machines, memory, networking, etc.). For example, a resource instance or unit may include a server or other virtual machine configured (e.g., with processors, memory, networking capability, etc.) to execute certain types of applications.

The tasks of the job group may be classified or categorized as shorter tasks or longer tasks relative to each other based on various attributes (e.g., resource requirements, duration, processing time, etc.). For example, one or more task attributes of a task (e.g., duration or processing time) may be compared to a threshold to classify the task as a shorter task or longer task. Alternatively, task attribute values (e.g., duration or processing time) of the tasks of the job group may be compared to each other, and the tasks classified based on a desired distribution for shorter and longer tasks (e.g., a certain percentage of tasks in the job group, etc.). For example, a desired distribution may include 30% of longer tasks. In this case, a job group may include one-hundred tasks, where seventy tasks with the shortest duration or processing time are considered the shorter tasks, and the remaining thirty tasks with the longer duration or processing time are considered the longer tasks.

Resource monitor module 230 further initiates tasks of jobs of the job group to be performed or executed on the acquired resources at operation 430. Shorter tasks of the job group are initially performed or executed on the revocable resources. The shorter tasks may be assigned to instances or units of the revocable resources in any fashion (e.g., sequentially or serially, randomly, predetermined mapping or priorities for the tasks and/or revocable resource instances, etc.).

Resource monitor module 230 further monitors the status of the revocable resource instances during performance of the tasks at operation 435. The resource monitor module monitors the revocable resource instances to identify stable and unstable instances. A revocable resource instance may be considered unstable when a task performed by the revocable resource instance is interrupted (e.g., the revocable resource instance is revoked or reclaimed by the resource provider, etc.) prior to completion. When an interruption occurs during task performance (e.g., the revocable resource instance is revoked or reclaimed by the resource provider), the task may be restarted when the revocable resource instance later becomes available. The shorter tasks serve as probes for identifying stable revocable resource instances for performing the longer tasks as described above. The shorter tasks are initially executed since the cost is low when a shorter task is interrupted.

When the shorter tasks are completed as determined at operation 440, the presence of unstable revocable resource instances is determined at operation 445. When one or more unstable revocable resource instances are identified, the unstable revocable resource instances are released at operation 450.

Resource monitor module 230 further initiates the longer tasks of the job group to be performed or executed on the stable revocable resource instances at operation 455. The longer tasks may be assigned to the stable revocable resource instances in any fashion (e.g., sequentially or serially, randomly, predetermined mapping or priorities for the tasks and/or revocable resource instances, etc.). When an interruption occurs during performance of a longer task (e.g., the revocable resource instance is revoked or reclaimed by the resource provider), the longer task may be restarted when the revocable resource instance later becomes available. The process repeats from operation 455 until the jobs of the job group are complete as determined at operation 460.

When the jobs of the job group are complete, resource analysis module 240 collects and analyzes the information of the resource providers (e.g., cloud or other computing resource provider (e.g., public cloud 105, etc.), etc.) at operation 465. The resource provider information may include various information pertaining to performance of the tasks of the job group by a corresponding resource provider (e.g., resource provider identifier, processing time, cost, time of day, location, etc.). This information is used for adjustment of the sub-requests to different resource providers at operation 420 for a subsequent execution or performance of tasks of the job group. For example, the resource provider information may indicate the costs for each service provider to perform the job group. In this case, the sub-requests are adjusted to provide a greater amount of sub-requests to (or request a greater amount of resources from) the resource provider having the lower cost. The adjustment may be based on various criteria (e.g., increased predetermined percentage (e.g., 25%, 50%, etc.), an amount in accordance with a ratio of resource provider costs, an amount in accordance with difference in costs, an amount to achieve a desired cost savings amount or range, etc.).

The above process is repeated from operation 410 for subsequent performance of the job group (e.g., periodic or scheduled jobs) until termination of the process (e.g., no further performance of the job group, etc.) as determined at operation 470. For example, the process may be applied to a daily job group to adjust the sub-requests for reduced cost. Since the sub-requests to each resource provider are adjusted dynamically, the resource provider completing jobs at reduced cost receives a greater quantity of the sub-requests (or requests for a greater quantity of resources), thereby reducing costs of performing the jobs of the job group.

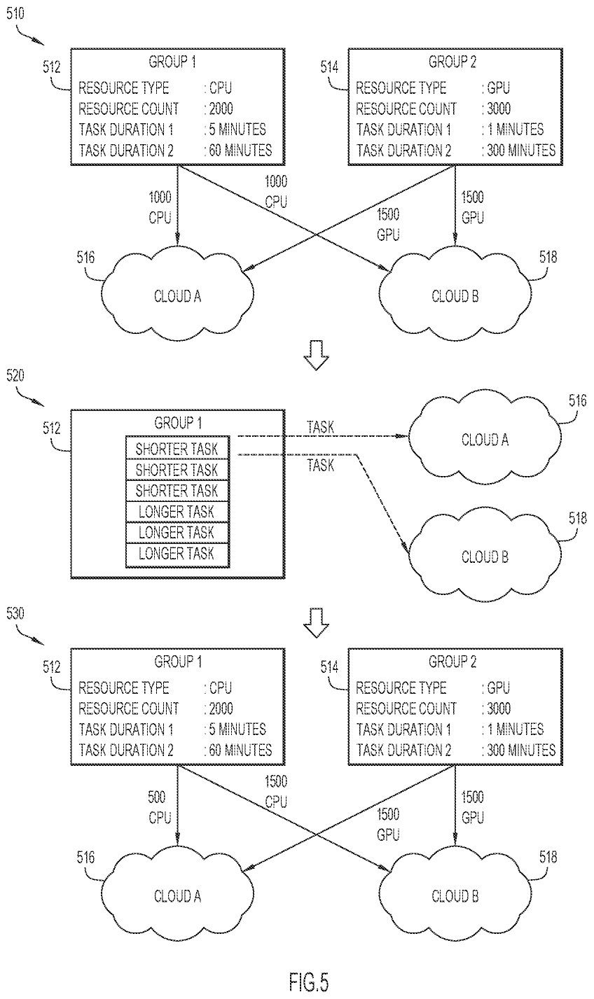

A flow diagram of an example scenario for performing jobs of job groups and dynamically adjusting resources according to an embodiment of the present invention is illustrated in FIG. 5. Initially, group formation module 210 collects various information pertaining to jobs of a workload, and divides or partitions the jobs into different job groups based on resource requests for the jobs in substantially the same manner described above. By way of example, flow 510 indicates the job groups include job group 512 (e.g., Group 1 as viewed in FIG. 5) and job group 514 (e.g., Group 2 as viewed in FIG. 5). Attributes of job group 512 (Group 1) include a resource type of CPU, a resource count of 2000, a duration for type 1 tasks of 5 minutes, and a duration for type 2 tasks of 60 minutes. Attributes of job group 514 (Group 2) include a resource type of GPU, a resource count of 3000, a duration for type 1 tasks of 1 minute, and a duration for type 2 tasks of 300 minutes. Resource providers for the job groups include resource provider 516 (e.g., Cloud A as viewed in FIG. 5) and resource provider 518 (e.g., Cloud B as viewed in FIG. 5).

Request partition module 220 divides resource requests for each job group 512 (Group 1), 514 (Group 2) into sub-requests. This may be performed randomly, or based on a previous analysis (when an analysis has been performed based on prior performance of the job group) in substantially the same manner described above. By way of example, flow 510 further indicates that job group 512 (Group 1) needs a total of 2000 CPU, and a resource request for that group is divided into two sub-requests each requesting 1000 CPU from a corresponding resource provider 516 (Cloud A), 518 (Cloud B). Job group 514 (Group 2) needs a total of 3000 GPU, and a resource request for that group is divided into two sub-requests each requesting 1500 GPU from a corresponding resource provider 516 (Cloud A), 518 (Cloud B).

Resource monitor module 230 sends the sub-requests for each group 512 (Group 1), 514 (Group 2) to corresponding resource providers 516 (Cloud A), 518 (Cloud B) to acquire the resources for performing tasks of those job groups in substantially the same manner described above. The requested resources include revocable resources (e.g., spot instances, etc.). These types of resources are provided when available (e.g., from excess or unused capacity of a resource provider, etc.) and have lower cost, but may be unilaterally revoked or reclaimed by the resource provider based on capacity needs or demands due to requests for resources from other users as described above. The requested (or acquired) resources (including the revocable resources) may include any quantity of instances or units of any types of resources (e.g., virtual machines, memory, networking, etc.). For example, a resource instance or unit may include a server or other virtual machine configured (e.g., with processors, memory, networking capability, etc.) to execute certain types of applications.

Resource monitor module 230 further initiates tasks to be performed or executed on the acquired resources, and monitors the status of the revocable resources during task performance in substantially the same manner described above. By way of example, flow 520 indicates that shorter tasks of job group 512 (Group 1) are initially sent. The shorter tasks of the job group serve as probes for identifying stable revocable resources for performing the longer tasks of the job group as described above. The longer tasks of the job group are performed or executed on the stable revocable resources as described above.

Resource analysis module 240 collects information of resource providers when the jobs of a job group are completed in substantially the same manner described above. By way of example, information for resource providers 516 (Cloud A), 518 (Cloud B) may be collected when the jobs of job group 512 (Group 1) are completed. The information may indicate that resource provider 516 (Cloud A) had an effective running time of 4000 hours with a cost of $5,000 during an approximate time interval from 2:00-4:00 PM in Location A, while resource provider 518 (Cloud B) had an effective running time of 6000 hours with a cost of $6,000 during an approximate time interval from 2:00-4:00 PM in Location B. The effective running time may not include time wasted by interruption of the tasks (due to the resource provider revoking or reclaiming a revocable resource). Accordingly, resource provider 518 (Cloud B) provides a lower cost per hour (e.g., $6000/6000 hours ($1.00/hour) for Cloud B provides a lower cost per hour than $5000/4000 hours ($1.25/hour) for Cloud A), and sub-requests for job group 512 (Group 1) are adjusted to provide a greater quantity of sub-requests to (or request a greater quantity of resources from) resource provider 518 (Cloud B).

As indicated by way of example in flow 530, the sub-requests of job group 512 (Group 1) are adjusted to increase the quantity of resources obtained from resource provider 518 (Cloud B). This may be accomplished by increasing the amount of resources requested in the sub-requests sent to resource provider 518 (Cloud B), or by providing a greater quantity of sub-requests to that resource provider. In this example case, job group 512 (Group 1) still needs a total of 2000 CPU, and the resource request for that group is divided into two sub-requests as described above. However, the sub-request for resource provider 516 (Cloud A) is reduced from 1000 CPU to 500 CPU, while the sub-request for resource provider 518 (Cloud B) is increased from 1000 CPU to 1500 CPU to provide reduced costs. The dynamic updating of sub-requests (or resources) is continually performed to ensure job completion at minimum cost.

It will be appreciated that the embodiments described above and illustrated in the drawings represent only a few of the many ways of implementing embodiments for dynamic adjustment of revocable resources in a multi-cloud environment for performing a workload.

The environment of the present invention embodiments may include any number of computer or other processing systems (e.g., client or end-user systems, server systems, cloud or distributed computing systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system. These systems may include any types of monitors and input devices (e.g., keyboard, mouse, voice recognition, etc.) to enter and/or view information.

It is to be understood that the software of the present invention embodiments (e.g., resource adjustment code 200, group formation module 210, request partition module 220, resource monitor module 230, resource analysis module 240, etc.) may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client, distributed computing, and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information. The database system may be implemented by any number of any conventional or other databases, data stores or storage structures (e.g., files, databases, data structures, data or other repositories, etc.) to store information. The database system may be included within or coupled to the server and/or client systems. The database systems and/or storage structures may be remote from or local to the computer or other processing systems, and may store any desired data.

The present invention embodiments may employ any number of any type of user interface (e.g., Graphical User Interface (GUI), command-line, prompt, etc.) for obtaining or providing information (e.g., resource provider information, requests for resources, job and/or task information, etc.), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

A report may include any information arranged in any fashion, and may be configurable based on rules or other criteria to provide desired information to a user (e.g., resource provider information, requests for resources, job and/or task information, etc.).

The present invention embodiments are not limited to the specific tasks or algorithms described above, but may be utilized for dynamic adjustment of any resources in any computing environments.

The jobs may be of any quantity, and a job may include any quantity of any types of tasks. A task may include any quantity of any types of operations (e.g., computational, data manipulation, access, and/or storage, communication operations, etc.). The jobs may be partitioned into any quantity of job groups based on any desired criteria (e.g., job quantity for a job group, job attributes, resources of the jobs, etc.). A job group may include any quantity of any types of jobs and/or tasks. A workload may include any quantity of any types of jobs and/or job groups, where a workload, job, and/or job group may include a set of any quantity of tasks.

The resources may be requested and/or obtained from any quantity of any types of resource providers of any computing or other resources (e.g., cloud or other distributed computing resource provider, etc.). The resources may include any types of resources (e.g., processing, memory, networking, etc.). The resources may include any quantity of any types of instances or units (e.g., server, container, or other virtual machines or environments, etc.). The requests for resources may include any information pertaining to the desired resources (e.g., quantities, types of resources, etc.). A resource request for a job group may be partitioned into any quantity of sub-requests based on any desired criteria (e.g., random, prior analysis, cost, etc.). A sub-request may be a request that requests any portion of resources needed for a corresponding job group (e.g., in any range from zero to one-hundred percent of the needed resources, etc.). The requests may request any quantity or combination of revocable resources and normal resources.

The tasks of a job group may include any quantity of shorter tasks and longer tasks. The shorter and longer tasks may be classified based on any desired criteria (e.g., duration, processing time, etc.). A resource may be considered stable based on any desired criteria (e.g., lack of interruption of a task, not being revoked for a certain time interval, etc.). Similarly, a resource may be considered unstable based on any desired criteria (e.g., interruption of a task, revoked within a certain time interval, etc.).

The requests for resources may be adjusted in any desired manner based on collected information (e.g., quantity of requests are adjusted to provide a greater quantity of requests to lower cost resource providers, adjusting an amount of resources requested, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of performing a workload with dynamic resource adjustment comprising:
requesting, via at least one processor, resources for a set of tasks from different resource providers, wherein the set of tasks includes first tasks and second tasks of longer duration than the first tasks, and wherein the resources are revocable by the different resource providers based on processing demand;
initiating, via the at least one processor, performance of the first tasks on the resources;
identifying, via the at least one processor, stable resources based on revocation of the resources during performance of the first tasks;
initiating performance of the second tasks on the identified stable resources; and
adjusting, via the at least one processor, requests for the resources to the different resource providers based on resource provider information collected in response to completion of the set of tasks.

2. The method of claim 1, wherein the different resource providers include cloud computing resource providers.

3. The method of claim 1, wherein the resources include resource instances comprising a virtual machine.

4. The method of claim 1, wherein the resources include spot instances.

5. The method of claim 1, wherein requesting resources for a set of tasks further comprises:
partitioning, via the at least one processor, a resource request for the set of tasks into a plurality of requests each requesting a portion of the resources; and
sending, via the at least one processor, the plurality of requests to the different resource providers to request the resources for the set of tasks.

6. The method of claim 1, wherein adjusting requests for the resources further comprises:
increasing a quantity of the resources requested from a resource provider having a lower cost based on the collected information.

7. The method of claim 1, further comprising:
partitioning, via the at least one processor, a plurality of jobs into job groups, wherein the set of tasks includes tasks of a corresponding job group.

8. A system for performing a workload with dynamic resource adjustment comprising:
one or more memories; and
at least one processor coupled to the one or more memories, wherein the at least one processor is configured to:
request resources for a set of tasks from different resource providers, wherein the set of tasks includes first tasks and second tasks of longer duration than the first tasks, and wherein the resources are revocable by the different resource providers based on processing demand;
initiate performance of the first tasks on the resources;
identify stable resources based on revocation of the resources during performance of the first tasks;
initiate performance of the second tasks on the identified stable resources; and
adjust requests for the resources to the different resource providers based on resource provider information collected in response to completion of the set of tasks.

9. The system of claim 8, wherein the different resource providers include cloud computing resource providers, and the resources include spot instances.

10. The system of claim 8, wherein the resources include resource instances comprising a virtual machine.

11. The system of claim 8, wherein requesting resources for a set of tasks further comprises:
partitioning a resource request for the set of tasks into a plurality of requests each requesting a portion of the resources; and
sending the plurality of requests to the different resource providers to request the resources for the set of tasks.

12. The system of claim 8, wherein adjusting requests for the resources further comprises:
increasing a quantity of the resources requested from a resource provider having a lower cost based on the collected information.

13. The system of claim 8, wherein the at least one processor is further configured to:
partition a plurality of jobs into job groups, wherein the set of tasks includes tasks of a corresponding job group.

14. A computer program product for performing a workload with dynamic resource adjustment, the computer program product comprising one or more computer readable storage media having program instructions collectively stored on the one or more computer readable storage media, the program instructions executable by at least one processor to cause the at least one processor to:
request resources for a set of tasks from different resource providers, wherein the set of tasks includes first tasks and second tasks of longer duration than the first tasks, and wherein the resources are revocable by the different resource providers based on processing demand;
initiate performance of the first tasks on the resources;
identify stable resources based on revocation of the resources during performance of the first tasks;
initiate performance of the second tasks on the identified stable resources; and
adjust requests for the resources to the different resource providers based on resource provider information collected in response to completion of the set of tasks.

15. The computer program product of claim 14, wherein the different resource providers include cloud computing resource providers.

16. The computer program product of claim 14, wherein the resources include resource instances comprising a virtual machine.

17. The computer program product of claim 14, wherein the resources include spot instances.

18. The computer program product of claim 14, wherein requesting resources for a set of tasks further comprises:
partitioning a resource request for the set of tasks into a plurality of requests each requesting a portion of the resources; and
sending the plurality of requests to the different resource providers to request the resources for the set of tasks.

19. The computer program product of claim 14, wherein adjusting requests for the resources further comprises:
increasing a quantity of the resources requested from a resource provider having a lower cost based on the collected information.

20. The computer program product of claim 14, wherein the program instructions further cause the at least one processor to:
partition a plurality of jobs into job groups, wherein the set of tasks includes tasks of a corresponding job group.
